(19) United States
(12) Patent Application Publication
(10) Pub. No.: US 2013/0227497 A1
(43) Pub. Date: Aug. 29, 2013

(54) APPARATUS AND METHOD FOR GENERATING STANDBY SCREEN

(71) Applicant: Pantech Co., Ltd., (KR)

(72) Inventors: Jin-Woo RYU, Goyang-si (KR); Mi-Young HWANG, Seoul (KR)

(73) Assignee: PANTECH CO., LTD., Seoul (KR)

(21) Appl. No.: 13/706,923

(22) Filed: Dec. 6, 2012

(30) Foreign Application Priority Data
Feb. 29, 2012 (KR) 10-2012-0021398

(51) Int. Cl. G06F 3/14

(52) U.S. Cl. CPC G06F 3/14
USPC 715/867

(57) ABSTRACT

An apparatus and method for generating a standby screen in a mobile terminal generates a standby screen which includes more than one image and may periodically replace or alter the displayed image. The method determines a grid layout of an output area of a screen and may configure each image to match a base cell or a random cell in size. The screen may include multiple layers and each layer may have a different image displayed thereon.

### CROSS-REFERENCE TO RELATED APPLICATION

This application claims priority from and the benefit under 35 U.S.C. §119(a) of Korean Patent Application No. 10-2012-0021398, filed on Feb. 29, 2012, which is incorporated by reference for all purposes as if fully set forth herein.

### BACKGROUND

1. Field

The following description relates to a display screen of a device, and more particularly, to an apparatus and method for generating a standby screen that is output in a hold state or in a screensaver state.

2. Discussion of the Background

Mobile phones including cellular phones, personal digital assistance (PDA) phones, etc. are in wide used. If a user opens the folder or presses a button of his or her mobile phone, a standby screen may be displayed on the display of the mobile phone. The standby screen generally shows information, such as time, date, etc., thereon. The user can select a standby screen from the menu of the mobile phone or download it through the Internet, etc.

In order to keep pace with the recent trend toward personalizing mobile phones, manufacturers of mobile phones are fabricating various kinds of products that enable users to freely express their personalities. For example, conventional mobile terminals could show only standby screens designated in advance by their manufacturers, however, recently, many mobile terminals have a standby screen selecting function to enable a user to freely set a standby screen of the mobile phone according to his or her taste. The user can set a standby screen using images stored in a memory upon fabricating the mobile terminal, images downloaded through the Internet, etc., or images photographed by a camera installed in the mobile phone.

However, typically, the standby screen is configured as a single image, and if the standby screen does not change for a long time, the user may feel boredom with the standby screen. In order to change the standby screen to another standby screen, the user may have to press several buttons, which consume time and cause inconvenience. Accordingly, the conventional mobile communication terminal has limitations in ensuring the variety of a standby screen by changing the background image, color, etc. of the standby screen.

### SUMMARY

Exemplary embodiments of the present invention provide an apparatus and method for simultaneously displaying a plurality of images as a standby screen in an electronic device.

Exemplary embodiments of the present invention also provide an apparatus and method for displaying images based on a grid.

Additional features of the invention will be set forth in the description which follows, and in part will be apparent from the description, or may be learned by practice of the invention.

An exemplary embodiment of the present invention discloses an apparatus to generate a standby screen, including: an input unit to receive an input request; a display to display a screen according to a grid; a controller to control the display of images on the screen according to the grid, and a grid layout setting unit to determine a layout of the grid of the screen, a size of a base cell of the grid, a size of a random cell of the grid and a location of the random cell on the grid, wherein the images are displayed on the screen according to at least one of the base cell and the random cell.

An exemplary embodiment of the present invention also discloses a method for generating a standby screen, the method including: determining a variables to generate a grid layout on an output area of a screen; generating the grid layout according to the variables of the output area of the screen; loading an image according to the grid layout; and displaying images on the screen according to the grid layout.

An exemplary embodiment of the present invention also discloses a method for generating a standby screen in a first layer and a second layer of a screen, the method including: determining variables to define a grid layout on the first layer and the second layer; generating the grid layout on the first layer and the second layer according to the variables; configuring images to be displayed on the first layer and the second layer to match a size of at least one of a base cell and a random cell; determining locations to display the images on the first layer and the second layer; and simultaneously displaying the images at the locations, wherein the first layer and the second layer overlap on the screen.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram of an apparatus to generate a standby screen based on a grid according to an exemplary embodiment of the present invention.

FIG. 2 is a diagram of a grid according to an exemplary embodiment of the present invention.

FIG. 3A is a diagram of an output area according to an exemplary embodiment of the present invention.

FIG. 3B is a diagram of an output area according to an exemplary embodiment of the present invention.

FIG. 4 is a diagram of a plurality of layers according to an exemplary embodiment of the present invention.

FIG. 5 is a diagram of a single layer according to an exemplary embodiment of the present invention.

FIG. 6 is a diagram of a method for adjusting the size of an image according to an exemplary embodiment of the present invention.

FIG. 7 is a flowchart of a method for generating a standby screen based on a grid according to an exemplary embodiment of the present invention.

FIG. 8 is a flowchart of a method for generating a standby screen based on a grid according to an exemplary embodiment of the present invention.

FIG. 9 is a flowchart of a method for generating a standby screen based on a grid according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

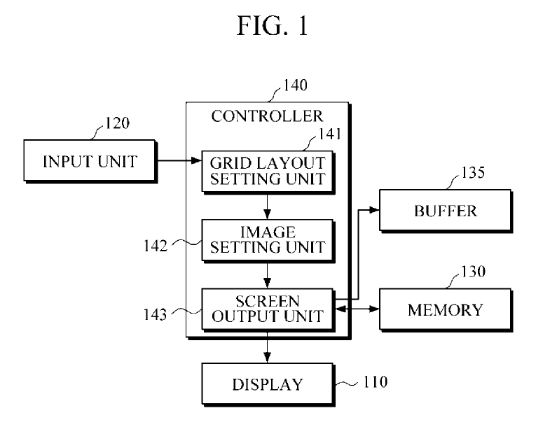

FIG. 1 is a diagram of an apparatus to generate a standby screen based on a grid according to an exemplary embodiment of the present invention.

Referring to FIG. 1, the apparatus includes a display 110, an input unit 120, a memory 130, a buffer 135, and a controller 140.

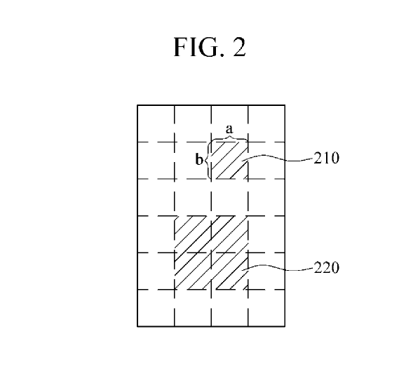

The display 110 may be configured to display a device state or a program execution state according to a control signal from the controller 140. The display 110 may be a liquid crystal display (LCD), a plasma display, a light emitting diode display, a cathode ray tube display, etc. The display 110 may configure images of various sizes as part of a dynamic screen in a grid form based on a base cell unit and may display the dynamic screen (herein after “screen”). The term “grid” will be described with reference to FIG. 2. Although, the display 110 and the input unit 120 are shown as separate components, aspects are not limited thereto and may be integrated together, such as, in a touch screen, a user interface, etc.

The input unit 120 may be an interface that can receive a user command. The input unit 120 may be a key input unit, a touch screen, a mouse, etc. that is configured to generate key data whenever a key button is pressed or activated. Information that will be processed by the controller 140 in connection with the display 110 may be received from a user through the input unit 120. At least one of output area information to generate a grid layout, information about a base cell size, information related to a random cell, information for selecting output images, and hold request information may be received from a user in the input unit 120 and output to the controller 140.

The memory 130 may be configured to store programs to control the operation of the device, such as, application programs, and data, etc. The buffer 135 may be a temporal storage unit, and may store images selected by an image setting unit 142. The temporal storage may store the selected images individually, in unit as a combination, or in unit as one or more standby screen sets, wherein each standby screen set may refer to a group of images that may be simultaneously output on a standby screen. The selected images or standby screen sets may be periodically replaced or altered. The selected images or standby screen sets may be altered by changing a property of the image, such as, brightness, color, color saturation, size, orientation, opaqueness, etc.

The controller 140 may be a hardware processor configured to control the above-described individual components to generate a grid-based standby screen, or a software module that is executed in the hardware processor. The controller 140 includes a grid layout setting unit 141, the image setting unit 142, and a screen output unit 143.

The grid layout setting unit 141 sets the format of a standby screen that is to be displayed on the display 110. The grid layout setting unit 141 may be configured to control a plurality of images to be output in a grid-based form.

FIG. 2 is a diagram of a grid according to an exemplary embodiment of the present invention.

A grid may refer to a lattice form or checker form, or a net into which a screen is segmented by vertical and horizontal straight lines. Quadrangles may be formed on the net and are referred to as cells, and a group of the cells is referred to as a grid layout. As shown in FIG. 2, a cell 210 is a base cell having a reference area with a horizontal length a and with a vertical length b. A cell 220 configured with two or more base cells may be referred to as a random cell.

Referring to FIG. 1 and FIG. 2, the grid layout setting unit 141 may determine a size of a base cell, and a size and location of a random cell in order to generate a grid layout. The grid layout setting unit 141 may set an output area so that images may be selectively displayed on the whole or a part of a screen.

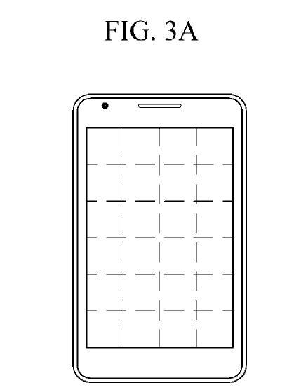

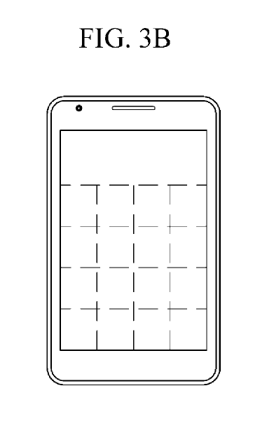

FIG. 3A is a diagram of an output area according to an exemplary embodiment of the present invention. FIG. 3B is a diagram of an output area according to an exemplary embodiment of the present invention. FIG. 3A illustrates a case where the entire area of a screen is set as an output area, and FIG. 3B illustrates a case where a part of a screen is set as an output area.

A method in which the grid layout setting unit 141 determines a size of a base cell will be described.

The grid layout setting unit 141 may acquire the number of cells in a horizontal direction, the number of cells in a vertical direction, and parameter values of an output area. Referring to FIG. 2, the number of cells in the horizontal direction is 4 and the number of cells in the vertical direction is 6.

The numbers of cells in the horizontal and vertical directions and the parameter values of the output area may be acquired using various methods. For example, the numbers of cells in the horizontal direction value, the vertical direction value, and the parameter value of the output area may be designated by a device manufacturer, or received from a user through the input unit 120.

The grid layout setting unit 141 may be configured to use the acquired horizontal direction value, vertical direction value, and parameter value to calculate the horizontal length and the vertical length of the base cell using Equation 1, below.

Horizontal Length of Base cell=Horizontal Length of Output Area/Number of Cells in Horizontal Direction

Vertical Length of Base cell=Vertical Length of Output Area/Number of Cells in Vertical Direction (1)

A method in which the grid layout setting unit 141 determines a size and location of a random cell will be described. The grid layout setting unit 141 calculates a size and location of a random cell having a size greater than that of the base cell, using Equation 2, below.

Horizontal Length of Random Cell=Horizontal Length of Base cell*Random Value 1

Vertical Length of Random Cell=Vertical Length of Base cell*Random Value 2

X coordinate of Random Cell=Random Value 3

Y coordinate of Random Cell=Random Value 4 (2)

Random values of Equation 2 may be values for determining the size of the random cell, and may be integers. In other words, an integer multiple of the horizontal length of the base cell may be obtained to decide the horizontal length of the random cell, and an integer multiple of the vertical size of the base cell may be obtained to decide the vertical size of the random cell. However, the random values do not need to be integers. The random values may be acquired using various methods. The random values may be values designated by a device manufacturer, or values received from a user through the input unit 120.

The grid layout setting unit 141 may configure base cells and random cells calculated as described above, on a single layer, or on separate layers of a screen.

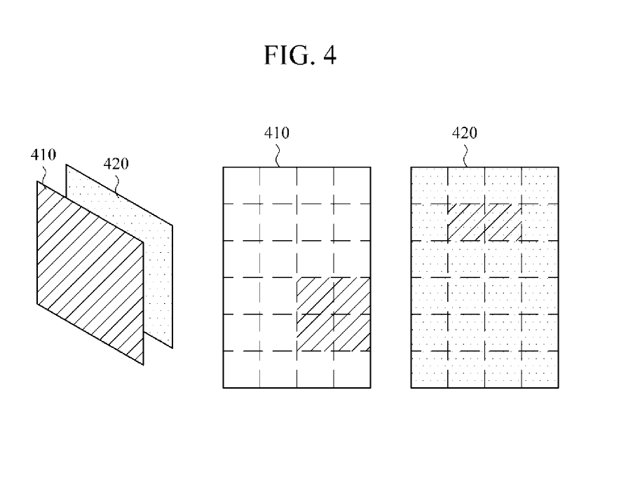

FIG. 4 is a diagram of a plurality of layers according to an exemplary embodiment of the present invention.

Referring to FIG. 4, base cells may be formed on layer 410 and random cells may be formed on layer 420.

A minimum unit for a layer configuration may be a base cell; however, a minimum unit size of a picture used as a standby screen is not limited to the size of the base cell. A minimum size of a picture used as a standby screen is referred to as a display unit. As illustrated in FIG. 4, a first layer 410 may be configured as a first display unit wherein each display unit includes four base cells, and a second layer 420 may be configured as a second display unit wherein each display unit includes two base cells.

The grid layout setting unit 141 may configure two or more layers. For example, a first layer may use a base cell as a display unit, a second layer may use a random cell including of two base cells as a display unit, and a third layer may use a random cell including of four base cells as a display unit.

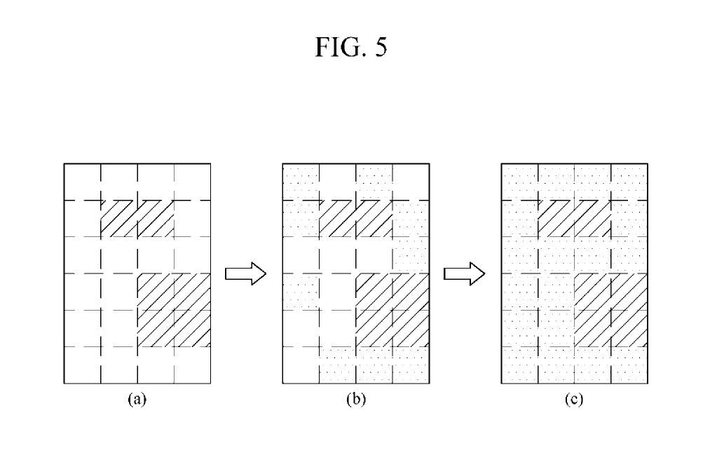

FIG. 5 is a diagram of a single layer according to an exemplary embodiment of the present invention.

Referring to FIG. 5, random cells may be set first as shown in screen (a) of FIG. 5, and then base cells may be set in spaces where no random cell is been set, as shown in screen (b) and screen (c) of FIG. 5. Configuring a single layer may have a higher effect on memory saving than configuring a plurality of layers.

Referring to FIG. 1 and FIG. 5, the image setting unit 142 may randomly selects a reference number of images from among images stored in the memory 130 or images selected by a user to configure a standby screen set, and may store the standby screen set in the buffer 135. The image setting unit 142 may configure a plurality of standby screen sets and store them in the buffer 135. According to exemplary embodiments, a method of listing images stored in the memory 130 is configured to configure one or more standby screen sets and to randomly map a target image included in the standby screen sets to a base cell or a random cell.

If a standby screen output event is generated, the screen output unit 143 may be configured to output one or more standby screen sets stored in the buffer 135 in a grid form set by the grid layout setting unit 141.

However, in many cases, the sizes of images are larger than those of the base cell or random cells in a screen. The screen output unit 143 may be configured to adjust the size of each image to the size of a base cell or a random cell.

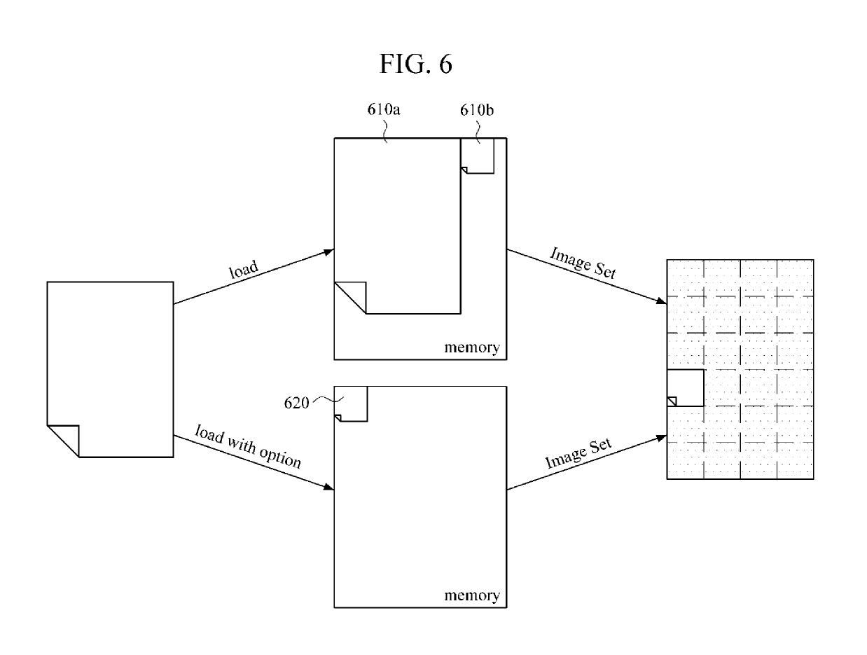

FIG. 6 is a diagram of a method for adjusting the size of an image according to an exemplary embodiment of the present invention.

FIG. 6 illustrates two methods for adjusting the size of an image, but aspects are not limited thereto. In operation 610a, the first method loads an image as it is in a memory. In operation 610b, the method proceeds to resize the image to a smaller size image, and then outputs the resized smaller image to a grid. The smaller image may be the same size as a base cell or random cell.

In operation 620, the second method loads an image using a memory capacity corresponding to a reference size after optionally allocating the reference size to the image and then to output the reference size of the image in a grid.

In order to output a plurality of images to a standby screen, the second method may save memory.

Referring again to FIG. 1 and FIG. 4, the screen output unit 143 may displays layer 410 and layer 420 such that they overlap with each other sequentially. The screen output unit 143 may display the layer 410 configured with random cells and displays the layer 420 configured with base cells thereon such that the layer 420 overlaps the layer 410. Conversely, layer 420 may be configured to display base cells and the layer 410 may be configured to display random cells. Moreover, each of the layer 410 and the layer 420 may be configured to display a combination of base cells and random cells.

The screen output unit 143 may be configured to display all random cells and base cells on a single layer. As shown in FIG. 5, the screen output unit 143 may be configured to display images in the random cells (screen (a) of FIG. 5) and then to display images in the remaining base cells (screen (b) and screen (c) of FIG. 5). Or, the screen output unit 143 may first display images in the base cells and thereafter display images in the random cells.

The screen output unit 143 may be configured to output images using an animation effect, such as, changing the speed at which images are displayed, the orientation of images, the movement of the image across the screen, iteratively output a set of successive images, such as, in a loop, etc. to continually change a standby screen.

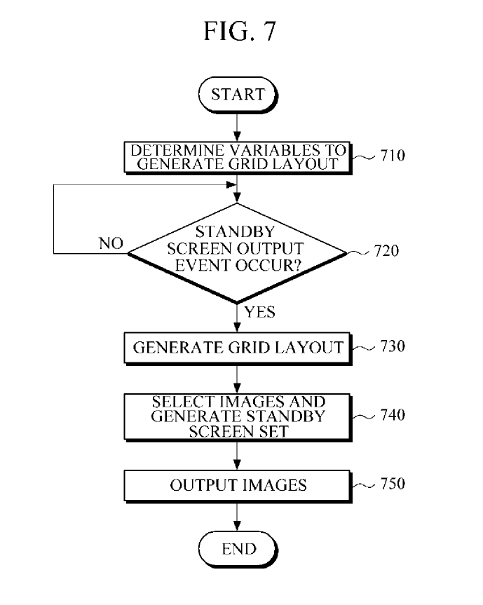

FIG. 7 is a flowchart of a method for generating a standby screen based on a grid according to an exemplary embodiment of the present invention.

Referring to FIG. 1 and FIG. 7, in operation 710, the controller 140 determines variables to generate a grid layout. The variables may include variables for determining a size of an output area, a size of a base cell, and the size and location of random cells. The variables may be obtained using various methods. For example, the variables may be default values set by a manufacturer, or may be received through the input unit 120 according to a setting value request from a user.

In operation 720, the controller 140 may be configured to determine whether a standby screen output event is occurs. The standby screen output event may include a device hold state request event, a screensaver output event, a display restart event, etc.

If a standby screen output event occurs, in operation 730, the controller 140 generates a grid layout. In operation 730, a format of a standby screen that is displayed on the display 110 may be set. A plurality of images may be output in a grid-based form. The controller 140 may determine a size of a base cell and a size and location of a random cell in order to generate a grid layout. In order to output images on the whole or a part of a screen, an output area may be determined.

The controller 140 calculates the size of a base cell, i.e., the horizontal length and the vertical length of a base cell, by applying the number of cells in a horizontal direction, the number of cells in a vertical direction, and parameter values of an output area, which have been acquired in operation 710, to Equation 1. The controller 140 calculates the size and location of a random cell having a size larger than that of the base cell, using Equation 2. After the size of the base cell and the size and location of the random cell are calculated, the number of images that are to be output through the grid layout is determined. Two methods may be used to output the images to the grid layout. The first method is to output images using a plurality of layers and the second method is to output images using a single layer. In the method of outputting images using a plurality of layers, random cells and base cells may be output through different layers, and in the method of outputting images using a single layer, random cells and base cells may be configured on a single layer.

In operation 740, the controller 140 randomly selects images according to the number of images determined in operation 730 from among images stored in the memory 130 or images selected by the user, configures a standby screen set using the selected images, and stores the standby screen set in the buffer 135. The controller 140 may configure a plurality of standby screen sets in advance and store them in the buffer 135. The controller 140 may lists images stored in the memory 130 to configure one or more standby screen sets, and may randomly map a target image to a base cell or a random cell. In many cases, the images may have a larger screen size than that of the base cell, and the size of each image may be adjusted to the size of the base cell or the random cell. A method of loading an image using a memory capacity according to a reference size after optionally allocating the reference size to the image may be used.

In operation 750, the controller 140 outputs the images stored in the buffer 135 in a grid form. There may be two output methods: one is a method of outputting images using a plurality of layers and the other is a method of outputting images using a single layer.

Although FIG. 7 has been described with reference to operation 710 through operation 750, the method of FIG. 7 is not limited thereto and various operations may be performed in a different sequence than described. For example, operation 710 of determining variables for generating a grid layout may be performed after operation 720 of determining if a standby screen output event occurs, and operation 730 and operation 740 may be performed before operation 720.

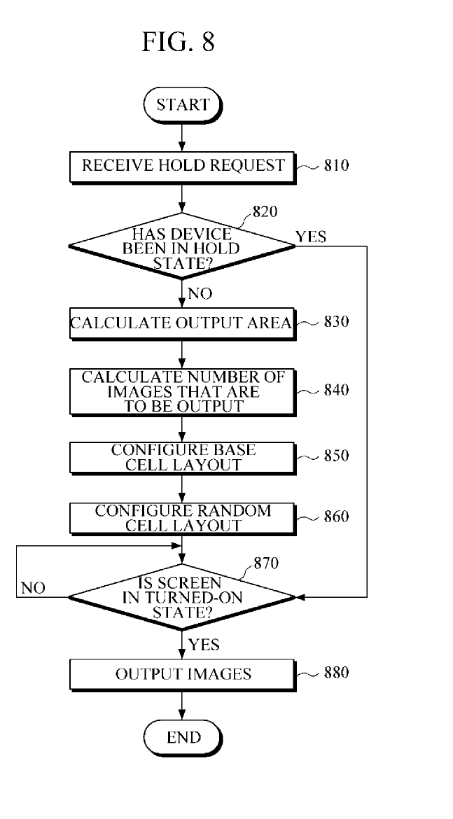

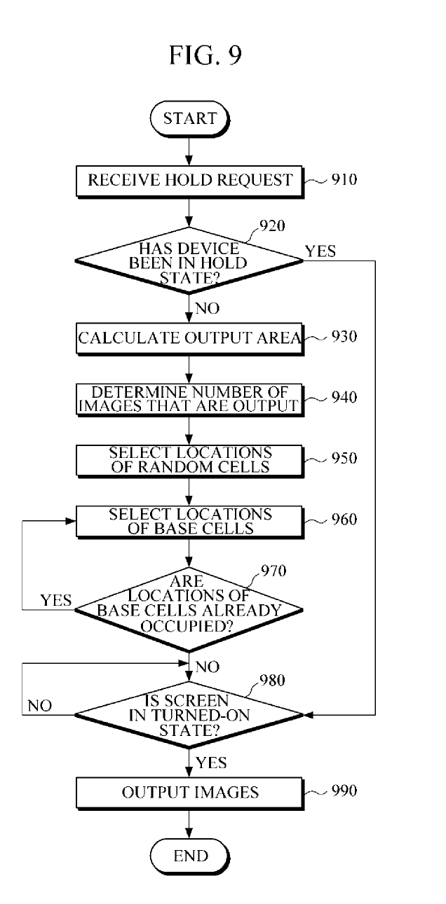

A method for generating a standby screen in response to a hold request will be described in more detail with reference to FIG. 8 and FIG. 9.

FIG. 8 is a flowchart of a method for generating a standby screen based on a grid according to an exemplary embodiment of the present invention.

Referring to FIG. 1 and FIG. 8, in operation 810, a hold request is received. In operation 820, the controller 140 determines whether the corresponding device has been in a hold state. For example, in the case of an Android smart phone, if a hold state is released to enter home, operations relating to a standby screen that had appeared in the previous hold state are stopped, and thereafter if the smart phone enters the hold state, a hold standby screen is generated. Accordingly, if a hold released state has changed to a hold state, the controller 140 configures a grid layout, whereas if a screen has been turned on in a hold state, the controller 140 may be configured to output images.

If it is determined in operation 820 that the device has been in a hold state, the process proceeds to operation 870, and determines if the screen is in a turned-on state. If the screen is in the turned-on state, in operation 880, the controller 140 outputs images.

If it is determined in operation 820 that the device has not been in a hold state, the controller 140 configures a grid layout. In order to configure a grid layout, the controller 140 determines a size of a base cell and a size and location of a random cell. The controller 140 determines an output area to output images on the whole or a part of a screen.

In operation 830, the controller 140 calculates the output area.

In operation 840, the controller 140 calculates the number of images that are to be output.

The controller 140 may be configured to calculate the size of a base cell, that is, the horizontal length and vertical length of a base cell, by applying the number of cells in a horizontal direction, the number of cells in a vertical direction, and parameter values of the output area to Equation 1. The controller 140 calculates the size and location of a random cell having a size larger than that of the base cell, using Equation 2. As described above, after the size of the base cell and the size and location of the random cell are calculated, the number of images that are to be output through the grid layout may be determined.

In operation 850, the controller 140 configures a base cell layout on a layer. In operation 860, the controller 140 configures a random cell layout on a layer. The random cell layout may be configured on the same layer as the base cell or on a different layer from the base cell layout.

In operation 870, the controller 140 determines whether a screen is in a turned-on state. If the screen is in the turned-on state, in operation 880, the controller 140 outputs the images. The images may be output on more than one layer of the screen. The more than one layer of the screens may be output to lay on top of each other. If more than one layer is output, each layer may be sequentially output.

If the screen is not in the turned-on state, the controller 140 monitors whether the screen is turned on.

Although FIG. 8 has been described with reference to operation 810 through operation 880, the method of FIG. 8 is not limited thereto and various operations may be performed in a different sequence than described.

FIG. 9 is a flowchart of a method for generating a standby screen based on a grid according to an exemplary embodiment of the present invention.

Referring to FIG. 1 and FIG. 9, in operation 910, a hold request is received. In operation 920, the controller 140 determines whether the corresponding device has been in a hold state.

If it is determined in operation 920 that the device has been in a hold state, the process proceeds to operation 980 to determine whether a screen is in a turned-on state. If the screen is in the turned-on state, in operation 990, images are output.

If it is determined in operation 920 that the device has not been in a hold state, the controller 140 configures a grid layout.

In operation 930, the controller 140 calculates an output area. In operation 940, the controller 140 calculates the sizes of a base cell and a random cell. In operation 940, the controller 140 may use the above-described method to select the number of images that are output through the grid layout.

In operation 950, the controller 140 selects the locations of the random cells in order to configure base cells and random cells on a single layer.

In operation 960, the controller 140 selects the locations of the base cells. In operation 970, the controller 140 determines whether the locations of the base cells have already been occupied by the random cells.

If the locations of the base cells have already been occupied by the random cells, the controller 140 decides the locations of the base cells by returning to operation 960.

If the locations of the base cells have not been occupied by the random cells, the controller 140 maintains the locations of the base cells.

If the locations of the base cells have not been occupied by the random cells, in operation 980, the controller 140 determines whether a screen is in a turned-on state. If the screen is in the turned-on state, in operation 990, the controller 140 outputs images. The images may be output on a single layer or more than one layer. However, if the screen is not in the turned-on state, the controller 140 monitors whether the screen is turned on.

Although FIG. 9 has been described with reference to operation 910 through operation 990, the method of FIG. 9 is not limited thereto and various operations may be performed in a different sequence than described.

As described above, according to the exemplary embodiments, by setting display information for simultaneously displaying a plurality of images to configure a standby screen, a user can change a standby screen through a simple manipulation.

In addition, by simultaneously displaying a reference number of images as a standby screen, a user can view a plurality of images at once.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to generate a standby screen, comprising:
an input unit to receive an input request;
a display to display a screen according to a grid;
a controller to control the display of images on the screen according to the grid, and
a grid layout setting unit to determine a layout of the grid of the screen, a size of a base cell of the grid, a size of a random cell of the grid and a location of the random cell on the grid,
wherein the images are displayed on the screen according to at least one of the base cell and the random cell.

2. The apparatus of claim 1, wherein the controller further comprises:
an image setting unit to select the images from a memory and to load the images according to the size of the base cell or the random cell.

3. The apparatus of claim 2, wherein the controller further comprises:
a screen output unit to control the output of the selected images to at least one layer of the screen.

4. The apparatus of claim 1, further comprising:
a buffer to store the selected images to be output to the screen.

5. The apparatus of claim 1, wherein the grid layout setting unit determines a size of a base cell, the size of a random cell and the location of the random cell on the screen according to a horizontal direction value, vertical direction value, and parameter values of an output area of the screen.

6. The apparatus of claim 1, wherein at least one of the images displayed on the screen and a property of the images displayed on the screen is periodically altered.

7. The apparatus of claim 3, wherein the screen has two or more layers.

8. The apparatus of claim 7, wherein the image setting unit selects a different image to be output to each layer of the screen.

9. The apparatus of claim 2, wherein the controller configures the size of the images to match the size of the base cell or the size of the random cell.

10. The apparatus of claim 1, wherein the input request is at least one of a device hold state request event, a screensaver output event, a display restart event.

11. A method for generating a standby screen, the method comprising:
determining variables to generate a grid layout on an output area of a screen;
generating the grid layout according to the variables of the output area of the screen;
loading an image according to the grid layout; and
displaying images on the screen according to the grid layout.

12. The method of claim 11, wherein determining a variable to generate a grid layout on an output area of a screen comprises at least one of:
determining a size of the output area;
determining a size of a base cell;
determining the size of a random cell; and
determining the location of a random cell.

13. The method of claim 12, wherein the standby screen output event is at least one of a device hold state request event, a screensaver output event, a display restart event.

14. The method of claim 12, wherein determining a size of a base cell comprises:
determining a horizontal length of the base call according to the number of base cells in the output area; and
determining a vertical length of a base cell according to the number of base cells in the output area.

15. The method of claim 11, wherein the screen comprises at least two layers and a different image is displayed on each layer of the screen.

16. The method of claim 11, wherein at least one of the images displayed on the screen and a property of the images displayed on the screen is periodically altered.

17. The method of claim 11, wherein generating the grid layout according to the variables of the output area of the screen comprises:
configuring the random cell according to the size and location of the random cell;
configuring the base cell according to the size of the base cell and to not overlap the location of the random cell.

18. The method of claim 12, wherein loading an image according to the grid layout comprises:
loading an image according to the size of the base cell or the random cell.

19. The method of claim 12, wherein loading an image according to the grid layout comprises:
loading an image; and
adjusting the size of the image according to the size of the base cell or the random cell.

20. A method for generating a standby screen in a first layer and a second layer of a screen, the method comprising:
determining variables to define a grid layout on the first layer and the second layer;
generating the grid layout on the first layer and the second layer according to the variables;
configuring images to be displayed on the first layer and the second layer to match a size of at least one of a base cell and a random cell;
determining locations to display the images on the first layer and the second layer; and
simultaneously displaying the images at the locations,
wherein the first layer and the second layer overlap on the screen.
